(19) United States
(12) Patent Application Publication
(10) Pub. No.: US 2016/0246619 A1
(43) Pub. Date: Aug. 25, 2016

(54) METHOD FOR HANDLING MODE SWITCHING WITH LESS UNNECESSARY REGISTER DATA ACCESS AND RELATED NON-TRANSITORY MACHINE READABLE MEDIUM

(71) Applicant: MEDIATEK INC., Hsin-Chu (TW)

(72) Inventors: Ya-Ting Chang, Hsinchu City (TW); Jia-Ming Chen, Hsinchu County (TW); Hung-Lin Chou, Hsinchu County (TW); Yu-Ming Lin, Taipei City (TW); Yu-Ting Chen, Taipei City (TW); Nicholas Ching Hui Tang, Hsinchu County (TW); Chia-Hao Hsu, Changhua County (TW)

(21) Appl. No.: 15/024,852

(22) PCT Filed: Aug. 31, 2015
(86) PCT No.: PCT/CN2015/088549

§ 371 Date: Mar. 24, 2016

Related U.S. Application Data
(60) Provisional application No. 62/045,082, filed on Sep. 3, 2014.

(51) Int. Cl. G06F 9/445; G06F 9/30

(52) U.S. Cl. CPC G06F 9/44505; G06F 9/30098

(57) ABSTRACT

A mode switching handling method includes: when an operating system mode is switched from a first mode to a second mode, saving only a portion of register data that are stored in registers into a storage device, wherein an M-bit register length is used in the first mode, an N-bit register length is used in the second mode, and M and N are different integers.

### CROSS REFERENCE TO RELATED APPLICATIONS

This application claims the benefit of U.S. provisional application No. 62/045,082, filed on Sep. 3, 2014 and incorporated herein by reference.

### TECHNICAL FIELD

The disclosed embodiments of the present invention relate to handling an operating system mode switching operation, and more particularly, to a method for handling mode switching with less unnecessary register data access and a related non-transitory machine readable medium.

### BACKGROUND

Processors are key components required by a variety of electronic devices. For example, an operating system (OS) can be executed by a processor of an electronic device to control execution of application software for performing the user's desired data processing. The operating system may switch between different operating modes, such as a user mode and a kernel mode. It is desirable that the switching from a first operating system mode to a second operating system mode should be reversible in that when a return is made to the first operating system mode due to exit of the second operating system mode, such that the first operating system mode will continue as if it had not been interrupted. In order to achieve such reversibility, it is necessary that the contents of various registers (e.g., registers inside the processor) should be saved upon leaving the first operating system mode so that they can be restored after the second operating system mode has finished its use of the registers (e.g., registers inside the processor) and control is returned to the first operating system mode. This is conventionally achieved by saving the register data of processor registers in the first operating system mode to an area of a stack memory allocated in an external dynamic random access memory (DRAM) upon leaving the first operating system mode and then returning these saved register data from the area of the stack memory to the processor registers upon returning to the first operating system mode.

A conventional mode switching handling approach is to save and restore contents of all registers used by the processor. However, a problem with this conventional approach is that operations of writing to and subsequently reading from the stack memory are relatively slow, which inevitably degrades the performance of the processor. Thus, there is a need for an innovative mode switching handling approach which is capable of avoiding/reducing the unnecessary register data access to speed up the mode switching operation.

### SUMMARY

In accordance with exemplary embodiments of the present invention, a method for handling mode switching with less unnecessary register data access and a related non-transitory machine readable medium are proposed.

According to a first aspect of the present invention, an exemplary mode switching handling method is disclosed. The exemplary mode switching handling method includes: when an operating system mode is switched from a first mode to a second mode, saving only a portion of register data that are stored in registers into a storage device, wherein an M-bit register length is used in the first mode, an N-bit register length is used in the second mode, and M and N are different integers.

According to a second aspect of the present invention, an exemplary mode switching handling method is disclosed. The exemplary mode switching handling method includes: when an operating system mode is switched from a second mode to a first mode, restoring a saved register data set in a storage device to only a portion of a storage space of registers, wherein an M-bit register length is used in the first mode, an N-bit register length is used in the second mode, and M and N are different integers.

According to a third aspect of the present invention, an exemplary non-transitory machine readable medium having a program code stored therein is disclosed. When executed by a processor, the program code causes the processor to execute following step: when an operating system mode is switched from a first mode to a second mode, saving only a portion of register data that are stored in registers into a storage device, wherein an M-bit register length is used in the first mode, an N-bit register length is used in the second mode, and M and N are different integers.

According to a fourth aspect of the present invention, an exemplary non-transitory machine readable medium having a program code stored therein is disclosed. When executed by a processor, the program code causes the processor to execute following step: when an operating system mode is switched from a second mode to a first mode, restoring a saved register data set in a storage device to only a portion of a storage space of registers, wherein an M-bit register length is used in the first mode, an N-bit register length is used in the second mode, and M and N are different integers.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating a processing system according to an embodiment of the present invention.

FIG. 2 is a diagram illustrating registers used by 32-bit processor architecture according to an embodiment of the present invention.

FIG. 3 is a diagram illustrating registers used by 64-bit processor architecture according to an embodiment of the present invention.

FIG. 4 is a diagram illustrating an example of a 64-bit general-purpose register.

FIG. 5 is a diagram illustrating an example of the first exemplary register data saving scheme.

FIG. 6 is a diagram illustrating an example of the second exemplary register data saving scheme.

FIG. 7 is a diagram illustrating an example of the third exemplary register data saving scheme.

FIG. 8 is a diagram illustrating an example of the first exemplary register data restoring scheme.

FIG. 9 is a diagram illustrating an example of the second exemplary register data restoring scheme.

FIG. 10 is a diagram illustrating an example of the third exemplary register data restoring scheme.

FIG. 11 and FIG. 12 are diagrams illustrating an example of applying the proposed mode switching handling approach in an ARM-based computer system.

FIG. 13 is a flowchart illustrating a mode switching handling method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

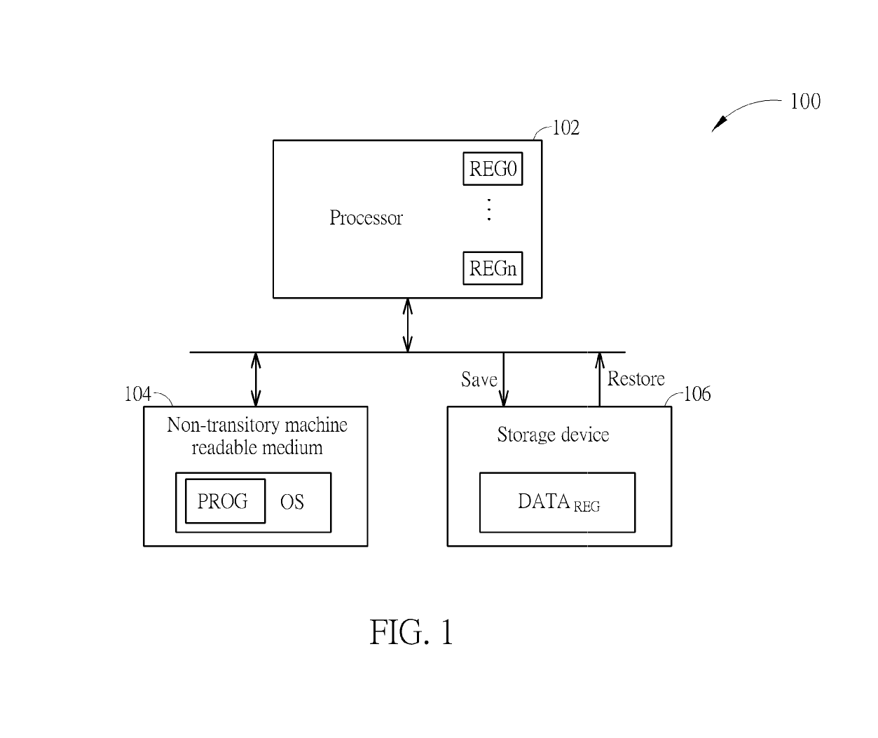

FIG. 1 is a block diagram illustrating a processing system according to an embodiment of the present invention. The processing system 100 may be part of an electronic device, such as a television, a mobile phone, a tablet, or a wearable device. The processing system 100 may include a processor 102, a non-transitory machine readable medium 104, and a storage device 106. It should be noted that only the components pertinent to the present invention are shown in FIG. 1. In practice, the processing system 100 may be configured to include additional components for achieving other functions. In this embodiment, the non-transitory machine readable medium 104 and the storage device 106 may be implemented using separate memory devices. For example, the non-transitory machine readable medium 104 may be a non-volatile memory such as a flash memory, and the storage device 106 may be a volatile memory such as a dynamic random access memory (DRAM). Alternatively, the non-transitory machine readable medium 104 and the storage device 106 may be implemented using separate memory spaces allocated in the same memory device. To put it simply, the present invention has no limitations on the actual implementation of the non-transitory machine readable medium 104 and the storage device 106.

The processor 102 may have a plurality of registers REG0-REGn included therein. When the processor 102 is an N-bit processor, most or all of the registers REG0-REGn may be N-bit registers. For example, the processor 102 may be a 64-bit ARM-based processor, and most of the registers REG0-REGn may be 64-bit registers. It should be noted that the number of registers REG0-REGn implemented in the same processor 102 may depend on the actual processor architecture of the processor 102. In this embodiment, the proposed method for handling mode switching with less unnecessary register data access may be applied to registers REG0-REGn inside the processor 102. However, this is for illustrative purposes only, and is not meant to be a limitation of the present invention. Alternatively, the proposed method for handling mode switching with less unnecessary register data access may be applied to registers used by any processing circuit and/or registers outside the processor 102.

The non-transitory machine readable medium 104 may be arranged to store a program code PROG. The program code PROG may be part of an operating system (OS) such as a Linux-based OS, and may be loaded and executed by the processor 102 to deal with a mode switching operation of the operating system mode. The storage device 106 may be arranged to have a stack memory allocated therein. Hence, when the operating system mode is switched from a first mode to a second mode, the instruction execution in the first mode may be interrupted, and the program code PROG running on the processor 102 may save register data of the processor 102 into the stack memory, such that a saved register data set DATA_{REG} may be available in the storage device 106. When the operating system mode is switched from the second mode to the first mode, the program code PROG running on the processor 102 may restore the saved register data set DATA_{REG} in the stack memory to the processor 102, thus enabling continued instruction execution in the first mode.

When the processor 102 is an N-bit processor, the processor 102 may be configured to operate in one of an N-bit mode, an N/2-bit mode, an N/4-bit mode, . . . , and an one-bit mode. Hence, it is possible that the processor 102 may operate in an N-bit mode (in which an N-bit register length may be used), and may operate in an M-bit mode (in which an M-bit register length may be used), where N and M may be different integers. Since the register utilization of the N-bit mode of the processor 102 may be different from the register utilization of the M-bit mode of the processor 102, saving/restoring the full register data of all registers REG0-REGn of the processor 102 may lead to unnecessary register data access as well as unnecessary storage device access. Compared to the conventional mode switching handling approach that saves/restores the full register data of all registers REG0-REGn of the processor 102, the proposed mode switching handling approach may avoid/reduce unnecessary register data access for achieving fast mode switching and reduced power consumption. Further details of the proposed mode switching handling approach are described as below.

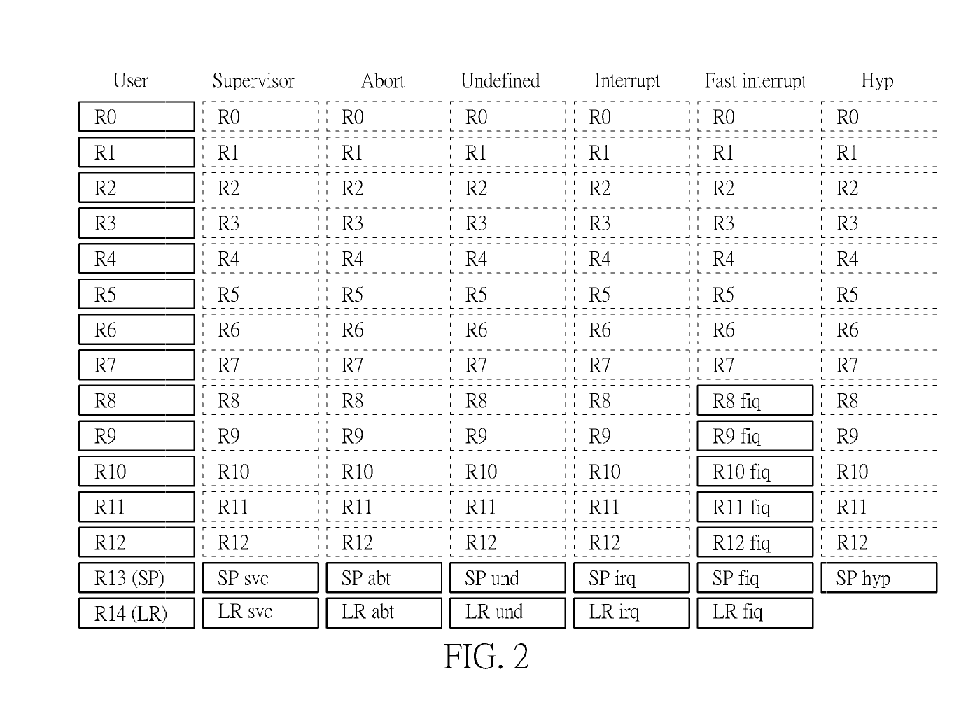

FIG. 2 is a diagram illustrating registers used by 32-bit processor architecture according to an embodiment of the present invention. The 32-bit processor architecture may support a plurality of processor modes, such as USR (user) mode, IRQ (interrupt) mode, FIQ (fast interrupt) mode, SVC (supervisor) mode, ABT (abort) mode, UND (undefined) mode, HYP (hypervisor) mode, etc. For example, when a user application is running in the operating system mode being a user mode, the processor may operate in the processor mode being the user mode; and when the operating system mode is switched from the user mode to a kernel mode, the processor may operate in the processor mode being the supervisor mode. As shown in FIG. 2, a set of registers R0-R7 may be shared by all processor modes. A first set of registers R8-R12 may be accessible in the user mode, and a second set of registers R8-R12 may be accessible in the fast interrupt mode. Each of the registers R13 may be a stack pointer (SP). Each of the registers R14 may be a link register (LR). As shown in FIG. 2, a first set of registers R13 and R14 may be accessible in the user mode, a second set of registers R13 and R14 may be accessible in the supervisor mode, a third set of registers R13 and R14 may be accessible in the abort mode, a fourth set of registers R13 and R14 may be accessible in the undefined mode, a fifth set of registers R13 and R14 may be accessible in the interrupt mode, and a sixth set of registers R13 and R14 may be accessible in the fast interrupt mode. Further, an additional register R13 may be accessible in the hypervisor mode. It should be noted that the 32-bit processor architecture may have additional registers (not shown), including a program counter (PC), a hypervisor mode register (ELR_Hyp), saved program status registers (SPSRs), etc.

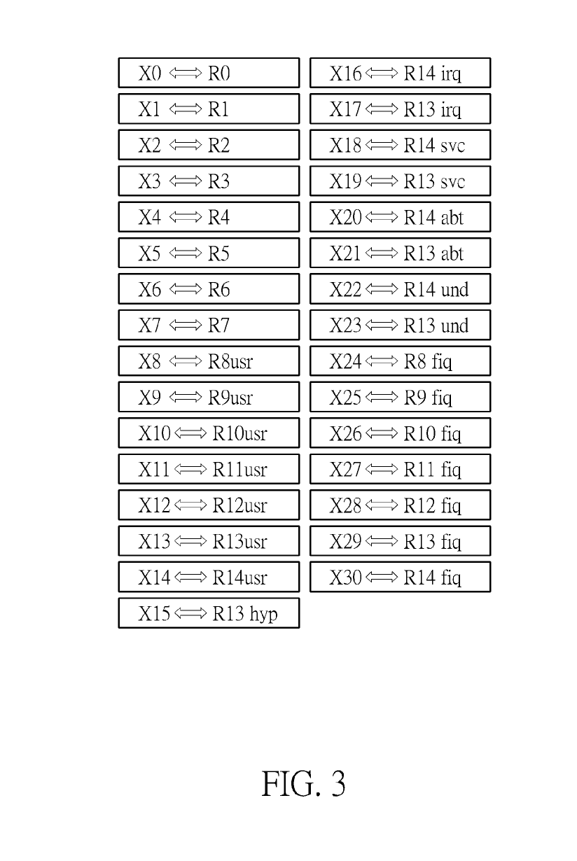

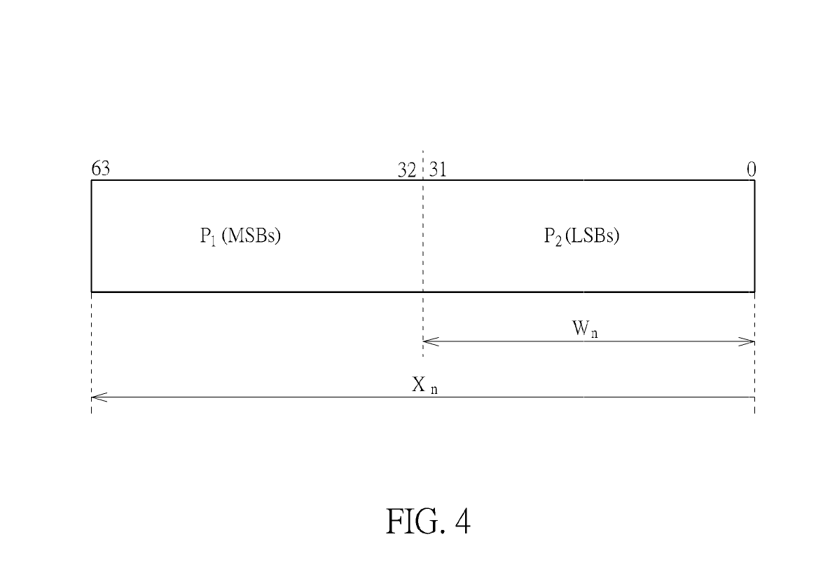

FIG. 3 is a diagram illustrating registers used by 64-bit processor architecture according to an embodiment of the present invention. As shown in FIG. 3, there may be thirty-one 64-bit general-purpose registers X0-X30, the lower halves of which may be accessible as W0-W30. The general-purpose registers X0-X30 may be all 64-bit wide to handle larger addresses for a 64-bit instruction set executed by a 64-bit processor. With regard to a 32-bit instruction set executed by the same 64-bit processor, 32-bit accesses may only use the lower halves W0-W30 of the 64-bit general-purpose registers X0-X30. FIG. 4 is a diagram illustrating an example of a 64-bit general-purpose register. The 64-bit general-purpose register may be divided into a upper-half part P₁ composed of more significant bits Bit[63:32] and a lower-half part P₂ composed of less significant bits Bit[31:0]. In a case where the 64-bit processor may be used to operate in a 64-bit mode in which a 64-bit register length may be used, both of the upper-half part P₁ and the lower-half part P₂ may be used. In another case where the 64-bit processor may be used to operate in a 32-bit mode in which a 32-bit register length may be used, only the lower-half part P₂ may be used, where the upper-half part P₁ may be either ignored or filled with 0's. Further, registers defined in the 32-bit processor architecture shown in FIG. 2 may be mapped onto the lower halves of the 64-bit general-purpose registers X0-X30 defined in the 64-bit processor architecture shown in FIG. 4, which enables running 32-bit instruction sets on the 64-bit processor architecture. It should be noted that the 64-bit processor architecture may have additional registers (not shown), including stack pointer registers, exception link registers, saved program status registers, etc.

By way of example, but not limitation, the processor 102 shown in FIG. 1 may be a 64-bit processor using at least the 64-bit general-purpose registers X0-X30 shown in FIG. 3. As mentioned above, when a user application is running in the operating system mode being a user mode, the processor may operate in the processor mode being the user mode; and when the operating system mode is switched from the user mode to the kernel mode, the processor may operate in the processor mode being the supervisor mode. In a case where the user application may be a 32-bit application and the operating system may be a 64-bit operating system, not all of the 64-bit general-purpose registers X0-X30 may be fully accessed in the user mode. For example, concerning the 64-bit general-purpose registers X0-X30, only the lower-half parts P₂ of some general-purpose registers X0-X14 may be accessed by the 32-bit application. Based on above observation, the present invention therefore proposes a partial register data saving/restoring scheme to enhance the mode switching efficiency.

Please refer to FIG. 1 again. The program code (e.g., mode switching handling program) PROG running on the processor 102 may be used to perform a save operation when an operating system mode is switched from a first mode to a second mode, where an M-bit register length may be used in the first mode, an N-bit register length may be used in the second mode, and M and N may be different integers. For example, the processor 102 may be a 64-bit processor (e.g., 64-bit ARM-based processor), the first mode may be a 32-bit user mode, and the second mode may be a 64-bit kernel mode. Hence, M may be smaller than N due to the fact that M=32 and N=64. For example, information recorded in program status registers (e.g., SPSRs) may be checked to decide whether the processor is operated in an N-bit instruction mode or an M-bit instruction mode and to decide whether the mode switching from a “USR” processor mode to an “SVC” processor mode occurs. However, this is for illustrative purposes only, and is not meant to be a limitation of the present invention. In practice, any means capable of checking if an operating system mode is switched from a short-bit mode to a long-bit mode may be adopted by the proposed mode switching handling approach.

When the operating system mode is switched from the first mode (e.g., 32-bit user mode) to the second mode (e.g., 64-bit kernel mode), the program code (e.g., mode switching handling program) PROG running on the processor (e.g., 64-bit processor) 102 may save only a portion of register data that are stored in registers (e.g., registers REG0-REGn inside the processor 102) into the storage device 106 to serve as the saved register data set DATA_{REG}.

With regard to several examples mentioned hereinafter, it is assumed that the general-purpose registers X0-X30 shown in FIG. 3 may be used. However, this is for illustrative purposes only, and is not meant to be a limitation of the present invention. In practice, the number of registers may be adjusted, depending upon actual design consideration. For example, the proposed method for handling mode switching with less unnecessary register data access may be applied to general-purpose registers X0-X40, and/or lower halves of the general-purpose registers X0-X15 may be accessed in the short-bit mode.

In a first exemplary register data saving scheme, the program code (e.g., mode switching handling program) PROG running on the processor (e.g., 64-bit processor) 102 may save a portion of a register data stored in each of the registers REG0-REGn into the storage device 106 to thereby create the saved register data set DATA_{REG}, where a remaining portion of the register data stored in each of the registers REG0-REGn may not be saved in the storage device 106. For example, the portion of the register data may be stored in the lower-half part P₂ of the register as shown in FIG. 4, and the remaining portion of the register data may be stored in the upper-half part P₁ of the register as shown in FIG. 4, where the lower-half part P₂ of the register may be allowed to be used in each of the first mode (e.g., user mode) and the second mode (e.g., kernel mode), and the upper-half part P₁ of the register may be allowed to be used in the second mode (e.g., kernel mode) but not the first mode (e.g., user mode).

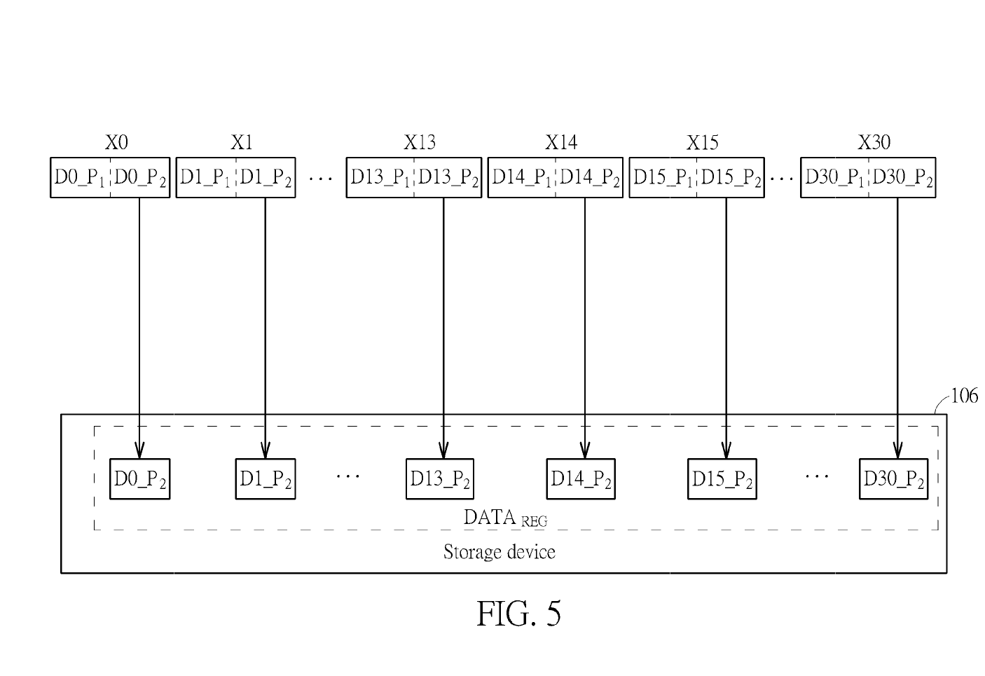

FIG. 5 is a diagram illustrating an example of the first exemplary register data saving scheme. Assume that the registers REG0-REGn may include the 64-bit general-purpose registers X0-X30 shown in FIG. 3. Hence, only the partial register data D0_P₂-D30_P₂ stored in lower-half parts of the general-purpose registers X0-X30 may be saved in the storage device 106. Compared to the conventional mode switching handling approach that saves the full register data of all general-purpose registers X0-X30, the proposed mode switching handling approach that only saves partial register data of all general-purpose registers X0-X30 may require less data access of the storage device 106. It should be noted that only the lower-half parts of the general-purpose registers X0-X14 may include valid register data of the first mode (e.g., user mode).

In a second exemplary register data saving scheme, the program code (e.g., mode switching handling program) PROG running on the processor (e.g., 64-bit processor) 102 may save a plurality of register data stored in a portion of the registers REG0-REGn of the processor 102 into the storage device 106 to thereby create the saved register data set DATA_{REG}, where a plurality of register data stored in a remaining portion of the registers REG0-REGn of the processor 102 may not be saved in the storage device 106. For example, the portion of the registers REG0-REGn may be allowed to be used in each of the first mode (e.g., user mode) and the second mode (e.g., kernel mode), and the remaining portion of the registers REG0-REGn may not be allowed to be used in the second mode (e.g., kernel mode) but not the first mode (e.g., user mode).

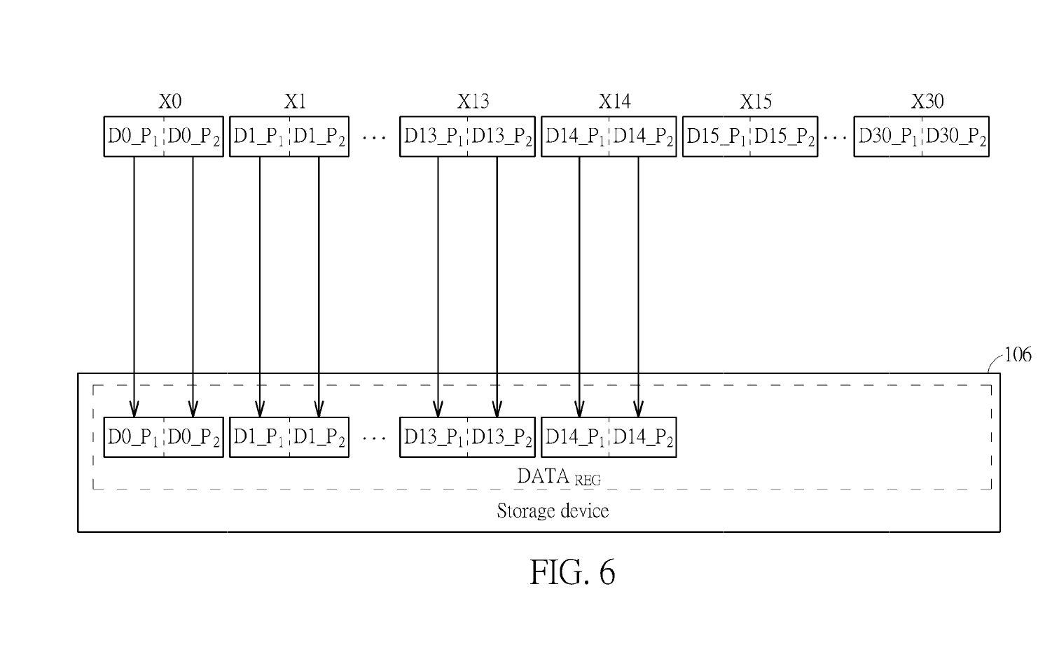

FIG. 6 is a diagram illustrating an example of the second exemplary register data saving scheme. Assume that the registers REG0-REGn may include the 64-bit general-purpose registers X0-X30 shown in FIG. 3. Hence, only the register data in some general-purpose registers X0-X14, including the partial register data D0_P₁-D14_P₁ in upper-half parts of general-purpose registers X0-X14 and partial register data D0_P₂-D14_P₂ in lower-half parts of general-purpose registers X0-X14, may be saved in the storage device 106. Compared to the conventional mode switching handling approach that saves the full register data of all general-purpose registers X0-X30, the proposed mode switching handling approach that only saves full register data of some general-purpose registers X0-X14 may require less data access of the storage device 106. It should be noted that only the lower-half parts of the general-purpose registers X0-X14 may include valid register data of the first mode (e.g., user mode).

In a third exemplary register data saving scheme, the program code (e.g., mode switching handling program) PROG running on the processor (e.g., 64-bit processor) 102 may save only a portion of a register data stored in each of a portion of the registers REG0-REGn of the processor 102 into the storage device 106 to thereby create the saved register data set DATA_{REG}. In other words, the third exemplary register data saving scheme may be regarded as having technical features of the first exemplary register data saving scheme and the second exemplary register data saving scheme.

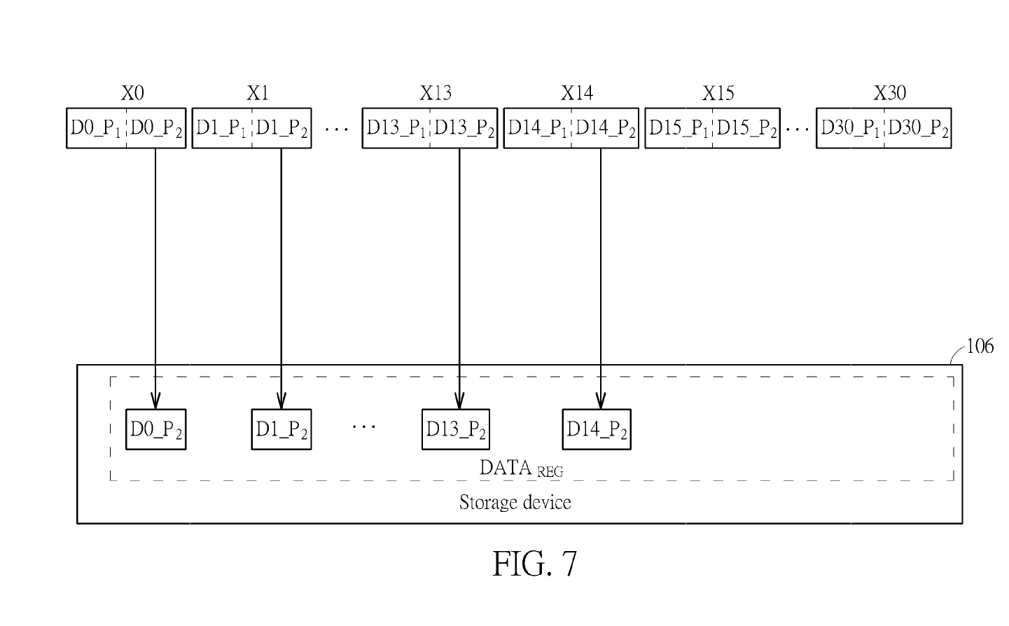

FIG. 7 is a diagram illustrating an example of the third exemplary register data saving scheme. Assume that the registers REG0-REGn may include the 64-bit general-purpose registers X0-X30 shown in FIG. 3. Hence, only the partial register data DO_P₂-D14_P₂ in lower-half parts of some general-purpose registers X0-X14 may be saved in the storage device 106. Compared to the conventional mode switching handling approach that saves the full register data of all general-purpose registers X0-X30, the proposed mode switching handling approach that only saves partial register data of some general-purpose registers X0-X14 may require less data access of the storage device 106. It should be noted that only the lower-half parts of the general-purpose registers X0-X14 may include valid register data of the first mode (e.g., user mode).

If the operating system mode is switched from the second mode (e.g., kernel mode) to the first mode (e.g., user mode) due to exit of the second mode (e.g., kernel mode), the program code PROG running on the processor 102 may restore the saved register data set DATA_{REG} in the storage device 106 to the processor 102 for resuming the instruction execution of the 32-bit application in the first mode (e.g., user mode). Hence, the program code (e.g., mode switching handling program) PROG running on the processor (e.g., 64-bit processor) 102 may further perform a restore operation when the operating system mode is switched from the second mode (e.g., kernel mode) to the first mode (e.g., user mode). For example, information recorded in program status registers (e.g., SPSRs) may be checked to decide whether the processor is operated in an N-bit instruction mode or an M-bit instruction mode and to decide whether the mode switching returning to a “USR” processor mode from an “SVC” processor mode occurs. However, this is for illustrative purposes only, and is not meant to be a limitation of the present invention. In practice, any means capable of checking if an operating system mode returns to a short-bit mode from a long-bit mode may be adopted by the proposed mode switching handling approach.

When the operating system mode is switched from the second mode (e.g., kernel mode) to the first mode (e.g., user mode), the program code (e.g., mode switching handling program) PROG running on the processor (e.g., 64-bit processor) 102 may restore the saved register data set DATA_{REG} in the storage device 106 to only a portion of a storage space of registers (e.g., registers REG0-REGn inside the processor 102).

In a first exemplary register data restoring scheme, the program code (e.g., mode switching handling program) PROG running on the processor (e.g., 64-bit processor) 102 may restore a register data included in the saved register data set DATA_{REG} (which may be saved according to the first exemplary register data saving scheme) to a portion of each register in the registers REG0-REGn of the processor 102, where no register data included in the saved register data set DATA_{REG} (which may be saved according to the first exemplary register data saving scheme) may be restored to a remaining portion of each register in the registers REG0-REGn of the processor 102. For example, the portion of the register may be the lower-half part P₂ of the register as shown in FIG. 4, and the remaining portion of the register may be the upper-half part P₁ of the register as shown in FIG. 4, where the lower-half part P₂ of the register may be allowed to be used in each of the first mode (e.g., user mode) and the second mode (e.g., kernel mode), and the upper-half part P₁ of the register may be allowed to be used in the second mode (e.g., kernel mode) but not the first mode (e.g., user mode).

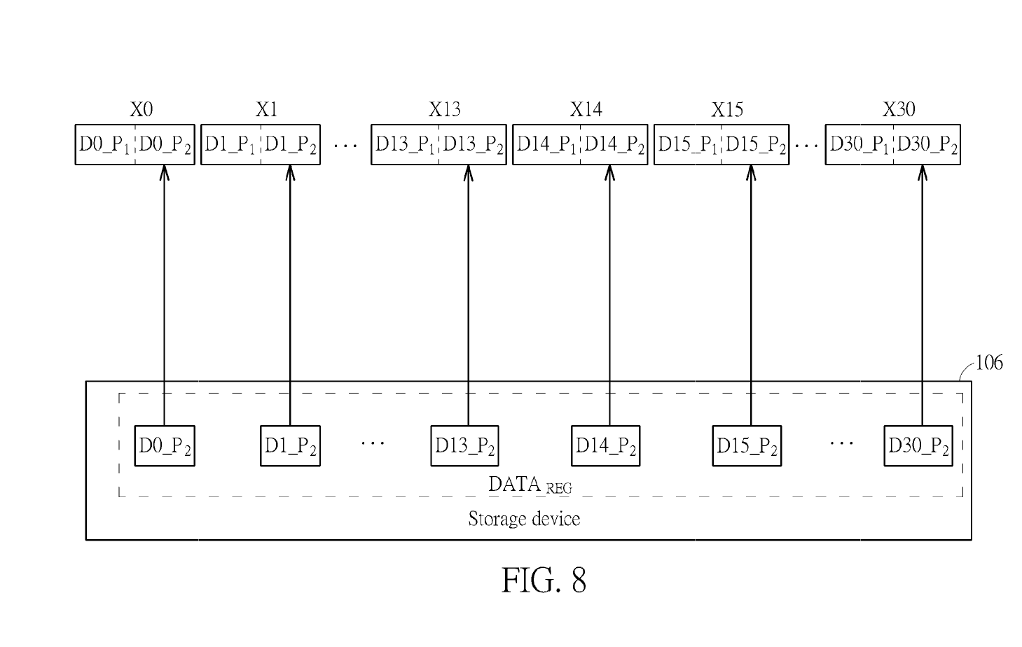

FIG. 8 is a diagram illustrating an example of the first exemplary register data restoring scheme. Assume that the registers REG0-REGn may include the 64-bit general-purpose registers X0-X30 shown in FIG. 3. Hence, a plurality of register data D0_P₂-D30_P₂ included in the saved register data set DATA_{REG} may be restored to only lower-half parts of the general-purpose registers X0-X30. Compared to the conventional mode switching handling approach that restores the full register data of all general-purpose registers X0-X30, the proposed mode switching handling approach that only restores partial register data of all general-purpose registers X0-X30 may require less data access of the storage device 106. It should be noted that only the lower-half parts of the general-purpose registers X0-X14 may be accessed in the first mode (e.g., user mode).

In a second exemplary register data restoring scheme, the program code (e.g., mode switching handling program) PROG running on the processor (e.g., 64-bit processor) 102 may restore a plurality of register data included in the saved register data set DATA_{REG} (which may be saved according to the second exemplary register data saving scheme) to a portion of the registers REG0-REGn of the processor 102, wherein no register data included in the saved register data set DATA_{REG} (which may be saved according to the second exemplary register data saving scheme) may be restored to a remaining portion of the registers REG0-REGn of the processor 102. For example, the portion of the registers REG0-REGn may be allowed to be used in each of the first mode (e.g., user mode) and the second mode (e.g., kernel mode), and the remaining portion of the registers REG0-REGn may be allowed to be used in the second mode (e.g., kernel mode) but not the first mode (e.g., user mode).

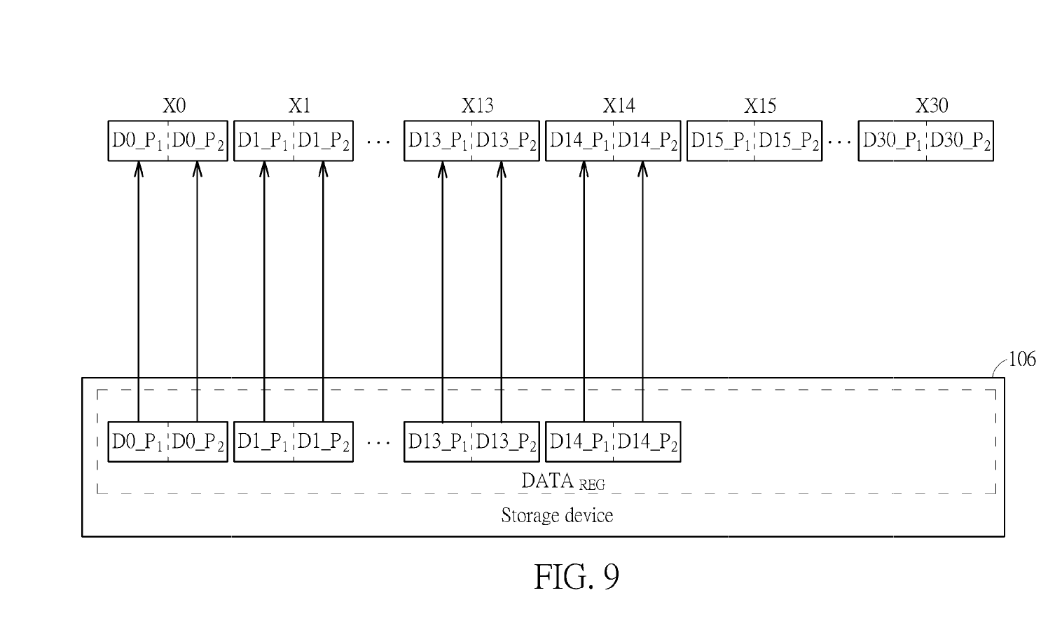

FIG. 9 is a diagram illustrating an example of the second exemplary register data restoring scheme. Assume that the registers REG0-REGn may include the 64-bit general-purpose registers X0-X30 shown in FIG. 3. Hence, a plurality of register data DO_P₁-D14_P₁ and DO_P₂-D14_P₂ included in the saved register data set DATA_{REG} may be restored to some general-purpose registers X0-X14 only. Compared to the conventional mode switching handling approach that restores the full register data of all general-purpose registers X0-X30, the proposed mode switching handling approach that only restores full register data of some general-purpose registers X0-X14 may require less data access of the storage device 106. It should be noted that only the lower-half parts of the general-purpose registers X0-X14 may be accessed in the first mode (e.g., user mode).

In a third exemplary register data restoring scheme, the program code (e.g., mode switching handling program) PROG running on the processor (e.g., 64-bit processor) 102 may restore a plurality of register data included in the saved register data set DATA_{REG} (which may be saved according to the third exemplary register data saving scheme) to only a portion of each register in a portion of the registers REG0-REGn of the processor 102. In other words, the third exemplary register data restoring scheme may be regarded as combining the technical features of the first exemplary register data restoring scheme and the second exemplary register data restoring scheme.

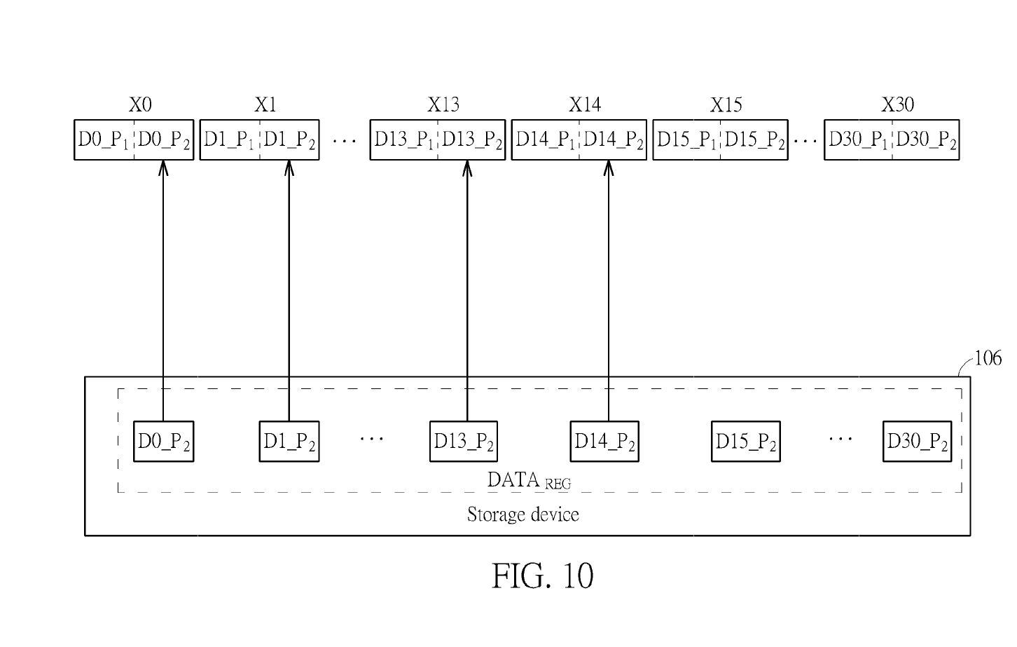

FIG. 10 is a diagram illustrating an example of the third exemplary register data restoring scheme. Assume that the registers REG0-REGn may include the 64-bit general-purpose registers X0-X30 shown in FIG. 3. Hence, a plurality of register data D0_P₂-D14_P₂ included in the saved register data set DATA_{REG} may be restored to lower-half parts of some general-purpose registers X0-X14 only. Compared to the conventional mode switching handling design that restores the full register data of all general-purpose registers X0-X30, the proposed mode switching handling approach that only restores partial register data of some general-purpose registers X0-X14 may require less data access of the storage device 106. It should be noted that only the lower-half parts of the general-purpose registers X0-X14 may be accessed in the first mode (e.g., user mode).

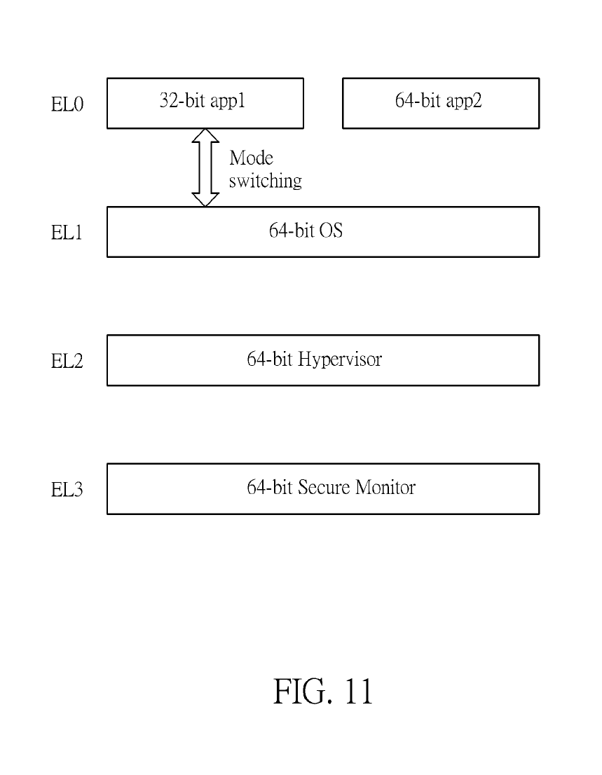

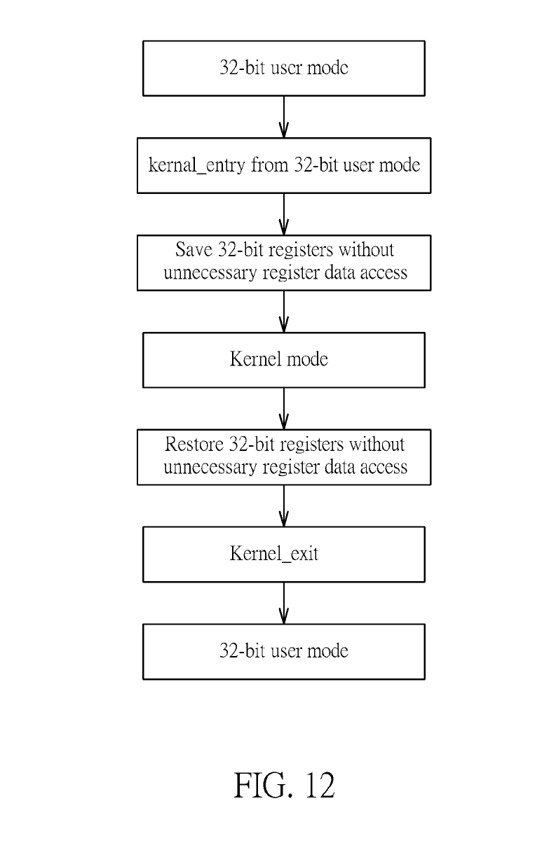

When one of the aforementioned exemplary register data saving schemes and one of the aforementioned exemplary register data restoring scheme are employed, some or all of the register access may be avoided to reduce the time needed for writing register data into the storage device 106 and reading register data from the storage device 106. FIG. 11 and FIG. 12 are diagrams illustrating an example of applying the proposed mode switching handling approach to an ARM-based computer system. A 64-bit ARM-based processor may support four exception levels EL0, EL1, EL2, and EL3, where the exception level EL3 may be the highest exception level with the most execution privilege. For example, the user mode may be categorized in the exception level EL0, and the supervisor mode may be categorized in the exception level EL1. When an operating system mode switching operation occurs between a 32-bit user mode and a 64-bit kernel mode, the use of the third exemplary register data saving scheme and the third exemplary register data restoring scheme mentioned above may skip upper-half parts of 64-bit registers and skip redundant 64-bit registers, thus only saving and restoring necessary register data for registers of the 64-bit ARM-based processor. In this way, fast mode switching for the ARM-based computer system can be achieved.

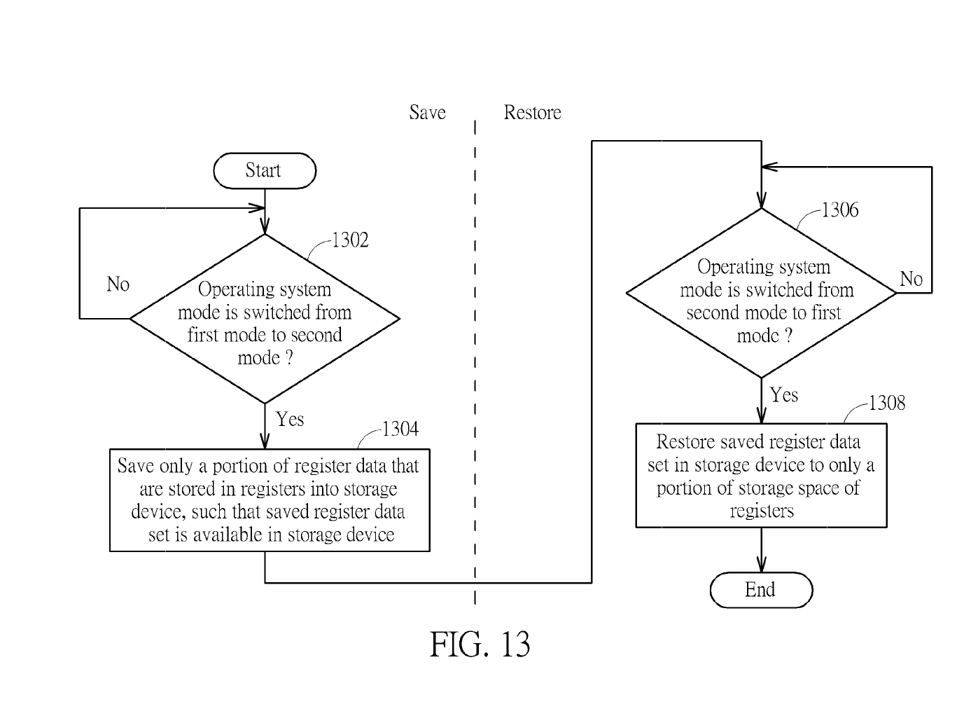

FIG. 13 is a flowchart illustrating a mode switching handling method according to an embodiment of the present invention. The mode switching handling method may be employed by the processing system 100 shown in FIG. 1. The steps are not required to be executed in the exact order shown in FIG. 13. Besides, one or more steps can be omitted from or added to the flow shown in FIG. 13. The mode switching handling method may be briefly summarized as below.

Step 1302: Is an operating system mode switched from a first mode (e.g., a user mode in which an M-bit register length is used) to a second mode (e.g., a kernel mode in which an N-bit register length is used, where N>M)? If yes, go to step 1304; otherwise, go to step 1302 to wait for occurrence of the operating system mode switching from a short-bit mode to a long-bit mode.

Step 1304: Save only a portion of register data that are stored in registers into a storage device, such that a saved register data set is available in the storage device.

Step 1306: If the operating system mode is switched from the second mode (e.g., kernel mode in which the N-bit register length is used) to the first mode (e.g., user mode in which the M-bit register length is used, where M<N)? If yes, go to step 1308; otherwise, go to step 1306 to wait for occurrence of the operating system mode switching from the long-bit mode to the short-bit mode.

Step 1308: Restore the saved register data set in the storage device to only a portion of a storage space of registers.

As a person skilled in the art can readily understand details of each step shown in FIG. 13 after reading above paragraphs, further description is omitted here for brevity.

In above exemplary embodiments, the processor 102 may be a 64-bit processor (e.g., a 64-bit ARM-based processor), the first mode may be an M-bit operating system mode (e.g., a 32-bit user mode), and the second mode may be an N-bit operating system mode (e.g., a 64-bit kernel mode). However, these are for illustrative purposes only, and are not meant to be limitations of the present invention. In practice, the proposed mode switching handling approach may be applied to any mode switching between a short-bit mode and a high-bit mode for avoiding some or all unnecessary data access in a storage device during the save phase and the restore phase of the mode switching.

Those skilled in the art will readily observe that numerous modifications and alterations of the device and method may be made while retaining the teachings of the invention. Accordingly, the above disclosure should be construed as limited only by the metes and bounds of the appended claims.

1. A mode switching handling method comprising:
when an operating system mode is switched from a first mode to a second mode, saving only a portion of register data that are stored in registers into a storage device;
wherein an M-bit register length is used in the first mode, an N-bit register length is used in the second mode, and M and N are different integers.

2. The mode switching handling method of claim 1, wherein M is smaller than N.

3. The mode switching handling method of claim 1, wherein saving only a portion of the register data that are stored in the registers into the storage device comprises:
saving a portion of a register data stored in a register into the storage device, wherein a remaining portion of the register data stored in the register is not saved in the storage device.

4. The mode switching handling method of claim 3, wherein the portion of the register data is stored in a lower-half part of the register, the remaining portion of the register data is stored in a upper-half part of the register, the lower-half part of the register is allowed to be used in each of the first mode and the second mode, and the upper-half part of the register is allowed to be used in the second mode but not the first mode.

5. The mode switching handling method of claim 1, wherein saving only a portion of the register data that are stored in the registers into the storage device comprises:
saving a plurality of register data stored in a portion of the registers into the storage device, wherein a plurality of register data stored in a remaining portion of the registers are not saved in the storage device.

6. The mode switching handling method of claim 5, wherein the portion of the registers are allowed to be used in each of the first mode and the second mode, and the remaining portion of the registers are allowed to be used in the second mode but not the first mode.

7. A mode switching handling method comprising:
when an operating system mode is switched from a second mode to a first mode, restoring a saved register data set in a storage device to only a portion of a storage space of registers;
wherein an M-bit register length is used in the first mode, an N-bit register length is used in the second mode, and M and N are different integers.

8. The mode switching handling method of claim 7, wherein M is smaller than N.

9. The mode switching handling method of claim 7, wherein restoring the saved register data set in the storage device to only a portion of the storage space of the registers comprises:
restoring a register data included in the saved register data set to a portion of a register, wherein no saved register data included in the saved register data set is restored to a remaining portion of the register.

10. The mode switching handling method of claim 9, wherein the portion of the register is a lower-half part of the register, the remaining portion of the register is a upper-half part of the register, the lower-half part of the register is allowed to be used in each of the first mode and the second mode, and the upper-half part of the register is allowed to be used in the second mode but not the first mode.

11. The mode switching handling method of claim 7, wherein restoring the saved register data set in the storage device to only a portion of the storage space of the registers comprises:
restoring a plurality of register data included in the saved register data set to a portion of the registers, respectively, wherein no register data included in the saved register data set are restored to a remaining portion of the registers.

12. The mode switching handling method of claim 11, wherein the portion of the registers are allowed to be used in each of the first mode and the second mode, and the remaining portion of the registers are allowed to be used in the second mode but not the first mode.

13. A non-transitory machine readable medium having a program code stored therein, wherein when executed by a processor, the program code causes the processor to execute following step:
when an operating system mode is switched from a first mode to a second mode, saving only a portion of register data that are stored in registers into a storage device;
wherein an M-bit register length is used in the first mode, an N-bit register length is used in the second mode, and M and N are different integers.

14. The non-transitory machine readable medium of claim 13, wherein M is smaller than N.

15. The non-transitory machine readable medium of claim 13, wherein saving only a portion of the register data that are stored in the registers into the storage device comprises:
saving a portion of a register data stored in a register into the storage device, wherein a remaining portion of the register data stored in the register is not saved in the storage device.

16. The non-transitory machine readable medium of claim 15, wherein the portion of the register data is stored in a lower-half part of the register, the remaining portion of the register data is stored in a upper-half part of the register, the lower-half part of the register is allowed to be used in each of the first mode and the second mode, and the upper-half part of the register is allowed to be used in the second mode but not the first mode.

17. The non-transitory machine readable medium of claim 13, wherein saving only a portion of the register data that are stored in the registers into the storage device comprises:
saving a plurality of register data stored in a portion of the registers into the storage device, wherein a plurality of register data stored in a remaining portion of the registers are not saved in the storage device.

18. The non-transitory machine readable medium of claim 17, wherein the portion of the registers are allowed to be used in each of the first mode and the second mode, and the remaining portion of the registers are allowed to be used in the second mode but not the first mode.

19. A non-transitory machine readable medium having a program code stored therein, wherein when executed by a processor, the program code causes the processor to execute following step:
when an operating system mode is switched from a second mode to a first mode, restoring a saved register data set in a storage device to only a portion of a storage space of registers;
wherein an M-bit register length is used in the first mode, an N-bit register length is used in the second mode, and M and N are different integers.

20. The non-transitory machine readable medium of claim 19, wherein M is smaller than N.

21. The non-transitory machine readable medium of claim 19, wherein restoring the saved register data set in the storage device to only a portion of the storage space of the registers of the processor comprises:
restoring a register data included in the saved register data set to a portion of a register, wherein no register data included in the saved register data set is restored to a remaining portion of the register.

22. The non-transitory machine readable medium of claim 21, wherein the portion of the register is a lower-half part of the register, the remaining portion of the register is a upper-half part of the register, the lower-half part of the register is allowed to be used in each of the first mode and the second mode, and the upper-half part of the register is allowed to be used in the second mode but not the first mode.

23. The non-transitory machine readable medium of claim 19, wherein restoring the saved register data set in the storage device to only a portion of the storage space of the registers comprises:
restoring a plurality of register data included in the saved register data set to a portion of the registers, respectively, wherein no register data included in the saved register data set are restored to a remaining portion of the registers.

24. The non-transitory machine readable medium of claim 23, wherein the portion of the registers are allowed to be used in each of the first mode and the second mode, and the remaining portion of the registers are allowed to be used in the second mode but not the first mode.
